(19) United States
(12) Patent Application Publication
(10) Pub. No.: US 2011/0219989 A1
(43) Pub. Date: Sep. 15, 2011

(54) LINEAR MOTOR AND TABLE FEED APPARATUS

(75) Inventors: Kazuya YUGAWA, Fukuoka (JP); Atsushi Kawahara, Fukuoka (JP); Seigo Nagamatsu, Fukuoka (JP)

(73) Assignee: KABUSHIKI KAISHA YASKAWA DENKI, Kitakyushu-shi (JP)

(21) Appl. No.: 13/042,477

(22) Filed: Mar. 8, 2011

(30) Foreign Application Priority Data
Mar. 11, 2010 (JP) 2010-055059
Mar. 19, 2010 (JP) 2010-064290
Mar. 19, 2010 (JP) 2010-064291

(51) Int. Cl. H02K 41/02; B23Q 1/44; B23Q 5/28

(52) U.S. Cl. 108/20; 310/12.25

(57) ABSTRACT

A linear motor includes a field magnet unit, an armature unit, and a connecting unit. The field magnet unit includes a first field magnet yoke and a second field magnet yoke each of which has an odd number of permanent magnets arranged thereon in a longitudinal direction such that polarities of the permanent magnets are alternately different, where the first field magnet yoke and the second field magnet yoke are arranged such that respective permanent magnets are opposite to each other and that polarities of the opposite permanent magnets are different from each other. The armature unit is wound with a winding and is arranged between the first field magnet yoke and the second field magnet yoke. The connecting unit is configured by a magnetic substance and connects the first field magnet yoke and the second field magnet yoke. One of the field magnet unit and the armature unit moves relatively to the other.

### CROSS-REFERENCE TO RELATED APPLICATIONS

This application is based upon and claims the benefit of priority of the prior Japanese Patent Application No. 2010-055059, filed on Mar. 11, 2010; Japanese Patent Application No. 2010-064290, filed on Mar. 19, 2010; and Japanese Patent Application No. 2010-064291, filed on Mar. 19, 2010, the entire contents of all of which are incorporated herein by reference.

### FIELD

The embodiments discussed herein are directed to a linear motor and a table feed apparatus.

### BACKGROUND

Conventionally, in order to reduce magnetic saturation of field magnet yokes attributable to downsizing of a linear motor and to avoid reduction of a generated electromagnetic thrust, there has been known a technique of setting the number of permanent magnets constituting a field magnet unit at an odd number. As related conventional techniques, there can be mentioned those described in Japanese Patent Laid-open Publication No. 2000-037070, Japanese Patent Laid-open Publication No. 2000-341930, and Japanese Laid-open Patent Publication No. 06-245480.

However, according to these conventional linear motors, because permanent magnets of a field magnet unit are at an odd number, a bias is generated in a magnetic flux density in a magnetic gap between the field magnet unit and an armature unit, and thus sufficient motor characteristics cannot be obtained in some cases.

### SUMMARY

A linear motor according to an aspect of embodiments includes a field magnet unit, an armature unit, and a connecting unit. The field magnet unit includes a first field magnet yoke and a second field magnet yoke each of which has an odd number of permanent magnets arranged thereon in a longitudinal direction such that polarities of the permanent magnets are alternately different, where the first field magnet yoke and the second field magnet yoke are arranged such that respective permanent magnets are opposite to each other and that polarities of the opposite permanent magnets are different from each other. The armature unit is wound with a winding and is arranged between the first field magnet yoke and the second field magnet yoke. The connecting unit is configured by a magnetic substance and connects the first field magnet yoke and the second field magnet yoke. One of the field magnet unit and the armature unit moves relatively to the other.

### BRIEF DESCRIPTION OF DRAWINGS

FIG. 1 is a perspective view of a field magnet unit of a linear motor according to a first embodiment;

FIGS. 2A and 2B are schematic diagrams for explaining a magnetic flux distribution of the field magnet unit according to the first embodiment;

FIG. 3 is a perspective view of a field magnet unit of a linear motor according to a modification of the first embodiment;

FIG. 4 is a perspective view of a field magnet unit of a linear motor according to a second embodiment;

FIG. 5 is a graph of a change of a magnetic flux density relative to a width of yoke fixing members according to the second embodiment;

FIG. 6 is a perspective view of a field magnet unit of a linear motor according to a modification of the second embodiment;

FIGS. 7A and 7B are an example in which the linear motor according to the first and second embodiments is applied to a table feed apparatus of a machine tool;

FIG. 8 is a perspective view of a field magnet unit of a linear motor according to a third embodiment;

FIGS. 9A and 9B are schematic diagrams for explaining a magnetic flux distribution in the field magnet unit according to the third embodiment;

FIG. 10 is a perspective view of a field magnet unit of a linear motor according to a modification of the third embodiment;

FIG. 11 is a perspective view of a field magnet unit of a linear motor according to a fourth embodiment;

FIG. 12 is a graph of a change of a magnetic flux density relative to a width of first and second fixing members according to the fourth embodiment;

FIG. 13 is a perspective view of a field magnet unit of a linear motor according to a modification of the fourth embodiment;

FIGS. 14A and 14B are an example in which the linear motor according to the third and fourth embodiments is applied to a table feed apparatus of a machine tool;

FIG. 15 is a perspective view of a field magnet unit of a linear motor according to a fifth embodiment;

FIG. 16 is a schematic diagram for explaining a magnetic flux distribution of the field magnet unit according to the fifth embodiment;

FIG. 17 is a perspective view of a field magnet unit of a linear motor according to a sixth embodiment; and

FIGS. 18A and 18B are an example in which the linear motor according to the fifth and sixth embodiments is applied to a table feed apparatus of a machine tool.

### DESCRIPTION OF EMBODIMENTS

A linear motor according to embodiments includes a field magnet unit, an armature unit, and a connecting unit. The field magnet unit includes a first field magnet yoke and a second field magnet yoke each of which has an odd number of permanent magnets arranged thereon in a longitudinal direction such that polarities of the permanent magnets are alternately different, where the first field magnet yoke and the second field magnet yoke are arranged such that respective permanent magnets are opposite to each other and that polarities of the opposite permanent magnets are different from each other. The armature unit is wound with a winding and is arranged between the first field magnet yoke and the second field magnet yoke. The connecting unit is configured by a magnetic substance and connects the first field magnet yoke and the second field magnet yoke. One of the field magnet unit and the armature unit moves relatively to the other.

A first embodiment is explained first.

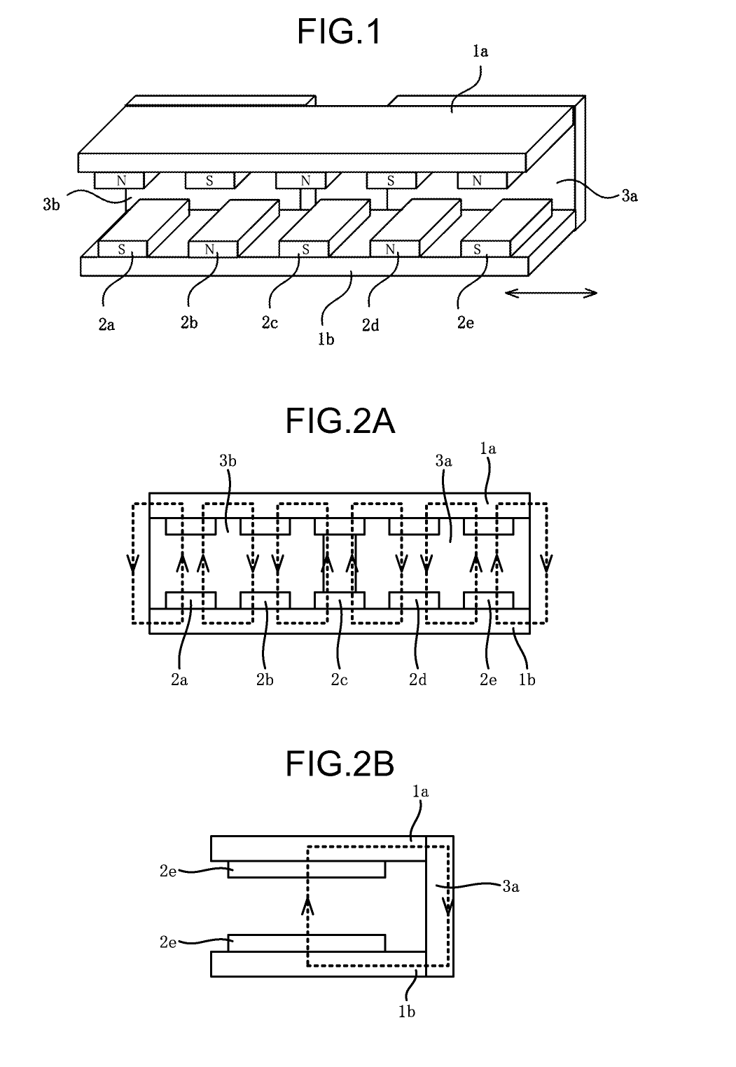

FIG. 1 is a perspective view of a field magnet unit of a linear motor according to the first embodiment. In FIG. 1, the field magnet unit is configured by a pair of tabular field magnet yokes 1a and 1b, and an odd number (five in this example) of permanent magnets 2a to 2e that are arranged on each of the field magnet yokes 1a and 1b along a longitudinal direction such that polarities of the permanent magnets are alternately different. The pair of field magnet yokes 1a and 1b on each of which the permanent magnets 2a to 2e that constitute the field magnet unit are arranged are connected to each other by two yoke fixing members 3a and 3b (a magnetic substance) such that one end in a direction orthogonal to the longitudinal direction of the field magnet yokes (the direction of an arrow in FIG. 1) is partially closed. The field magnet yokes 1a and 1b are arranged at symmetrical positions at both ends along the longitudinal direction of the field magnet yokes. The direction of the arrow in FIG. 1 represents a moving direction of the field magnet unit.

FIGS. 2A and 2B are schematic diagrams for explaining a magnetic flux distribution of the field magnet unit according to the first embodiment. FIG. 2A is a front view of the field magnet unit, and FIG. 2B is a side view of the field magnet unit. Dashed-line arrows in FIGS. 2A and 2B represent a flow of a magnetic flux. As shown in FIGS. 2A and 2B, because the field magnet unit includes the yoke fixing members 3a and 3b that partially connect the field magnet yokes 1a and 1b, a magnetic circuit is formed, which passes through the permanent magnets 2a to 2e, the field magnet yokes 1a and 1b, and the yoke fixing members 3a and 3b via a magnetic gap. Therefore, the field magnet unit from a viewpoint of an armature unit (not shown) has relatively cyclical boundaries at both ends of the field magnet unit, and becomes equivalent to a field magnet unit that has an even number of field magnets.

As described above, in the first embodiment, in an odd-numbered-pole field-magnet linear motor that constitutes the field magnet unit having an odd number of the permanent magnets 2a to 2e, the two yoke fixing units 3a and 3b are provided on the field magnet yokes 1a and 1b to connect the field magnet yokes 1a and 1b such that one end in a direction orthogonal to a moving direction of the field magnet yokes is partially closed. With this arrangement, leakage magnetic fluxes at both ends of the field magnet yokes can be reduced. Therefore, the field magnet unit from the viewpoint of the armature unit has relatively cyclical boundaries at both ends of the field magnet unit, and can obtain field magnets that are equivalent to those having an even number of poles.

A modification of the first embodiment is explained next.

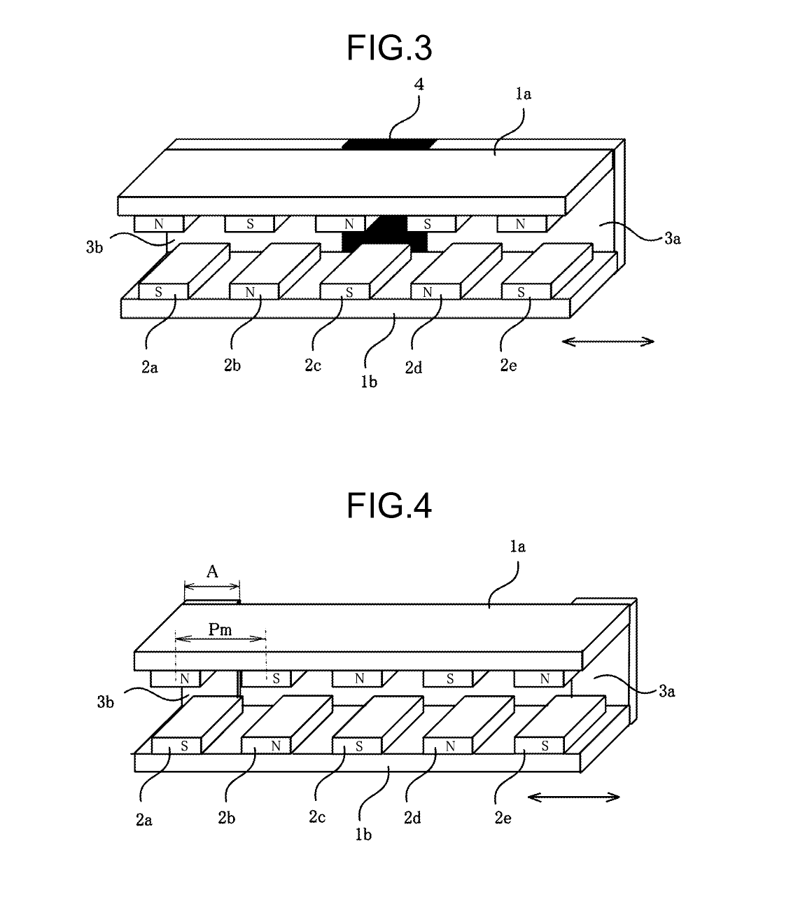

FIG. 3 is a perspective view of a field magnet unit of a linear motor according to the modification of the first embodiment.

In FIG. 3, the field magnet unit according to the first embodiment can be configured such that a nonmagnetic member 4 that becomes a strength member is provided in a space between the yoke fixing members 3a and 3b. With this arrangement, a linear motor that is compact, lightweight, and economic and avoids reduction of motor characteristics by maintaining the strength while improving manufacturability can be provided although in odd-numbered-pole field magnets.

A second embodiment is explained next.

FIG. 4 is a perspective view of a field magnet unit of a linear motor according to the second embodiment. In FIG. 4, the second embodiment is different from the first embodiment in that a width A of each of the yoke fixing members 3a and 3b is equal to or larger than a length of a pole pitch Pm of the permanent magnets 2a to 2e.

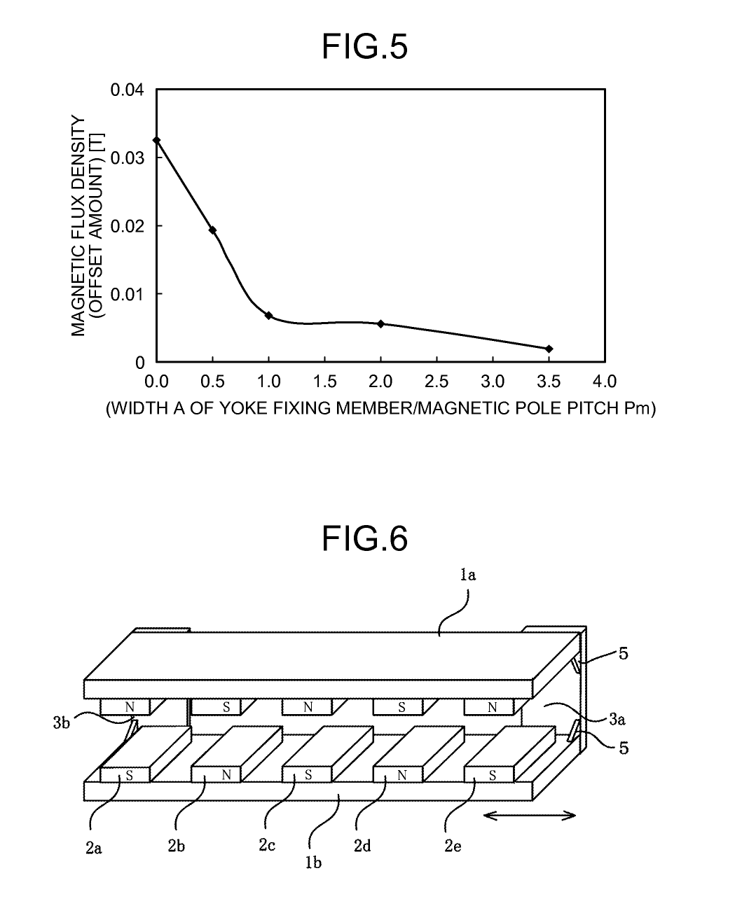

FIG. 5 is a graph of a change of a magnetic flux density relative to a width of yoke fixing members according to the second embodiment. The lateral axis represents the ratio of the width A of the yoke fixing members to the magnetic pole pitch Pm, and the vertical axis represents a numerical value of a magnetic flux density (T) at a center portion of the permanent magnets in a thickness direction. FIG. 5 depicts a relationship between this ratio and the magnetic flux density. It is clear from FIG. 5 that an offset amount of the magnetic flux of the permanent magnets becomes equal to or smaller than 0.005 and becomes stable when A/Pm is equal to or higher than 1.0. Therefore, leakage magnetic fluxes at both ends of the field magnet yokes can be optimally reduced by setting the width of the yoke fixing members at equal to or larger than the pole pitch of the permanent magnets.

In addition, because operations of the second embodiment are basically the same as those of the first embodiment, explanations thereof will be omitted.

Because the field magnet unit according to the second embodiment is configured as described above, the field magnet unit also includes the yoke fixing members 3a and 3b that partially connect the field magnet yokes 1a and 1b in a similar manner to that in the first embodiment. However, the width of each yoke fixing members is set equal to or larger than the length of the polar pitch of the permanent magnets 2a to 2e. With this arrangement, leakage magnetic fluxes at both ends of the field magnet yokes can be reduced more than those in the first embodiment. From a viewpoint of the armature unit, relatively cyclical boundaries are present at both ends of the field magnet unit. As a result, field magnets that are equivalent to those having an even number of poles can be obtained.

A modification of the second embodiment is explained next.

FIG. 6 is a perspective view of a field magnet unit of a linear motor according to the modification of the second embodiment. In FIG. 6, the field magnet unit according to the second embodiment can be configured such that nonmagnetic members 5 arranged at both ends of the field magnet yokes 1a and 1b that become strength members are provided at connecting portions between the yoke fixing members 3a and 3b and the field magnet yokes 1a and 1b . With this arrangement, a linear motor that is compact, lightweight, and economic and avoids reduction of motor characteristics by maintaining the strength while improving manufacturability can be provided although in odd-numbered-pole field magnets.

An example in which the linear motor according to the first and second embodiments is applied to a table feed apparatus of a machine tool is explained next.

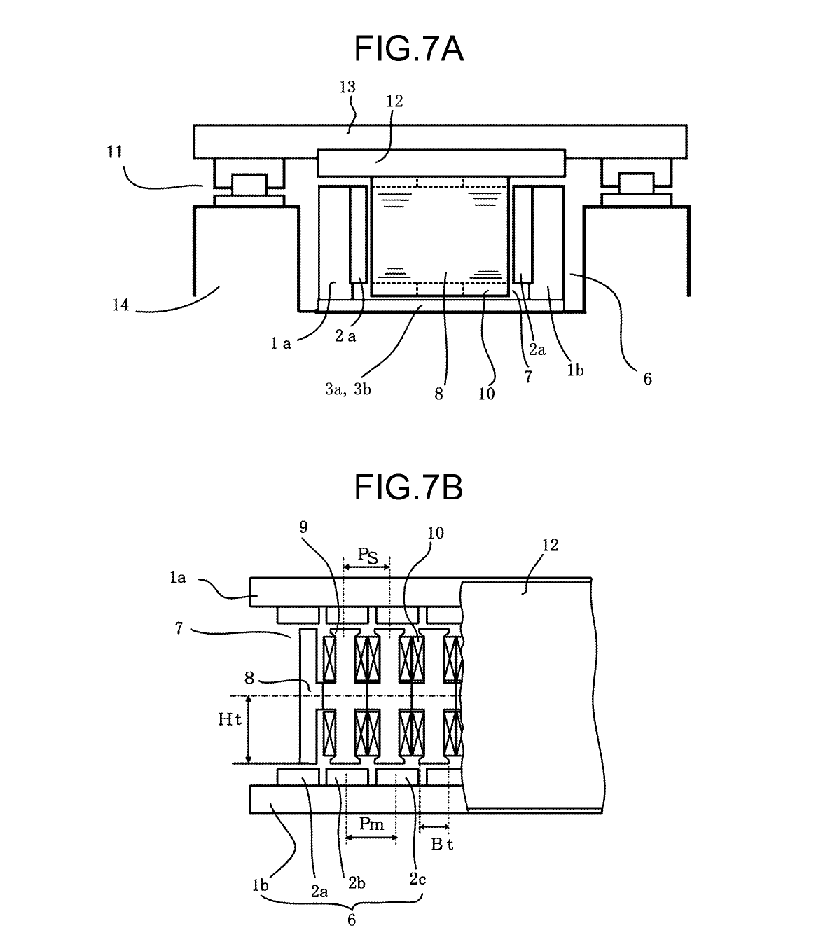

FIGS. 7A and 7B are an example in which the linear motor according to the first and second embodiments is applied to a table feed apparatus of a machine tool. FIG. 7A is a side cross-sectional view of the table feed apparatus, and FIG. 7B is a plan view of the table feed apparatus. FIG. 7B depicts a state where a table in FIG. 7A is removed and that the table feed apparatus is viewed from above in an advancing direction. In FIGS. 7A and 7B, the linear motor is configured such that a field magnet unit 6 that has plural permanent magnets (2a, 2b, . . . ) adjacently arranged along an advancing direction on the field magnet yokes 1a and 1b is used as a stator and that an armature unit 7 that is formed by having an armature winding 10 wound around an armature core 8 is used as a movable element. In this linear motor, ends of the field magnet yokes 1a and 1b are partially connected by the yoke fixing members 3a and 3b along the advancing direction. A table 13 is provided via an armature fitting plate 12 on an upper surface of the armature unit 7 that constitutes the movable element. The movable element is slidably supported by a linear guide 11 that is provided on a fixing table 14.

As explained above, a high-precision positioning feed can be achieved by applying a compact and lightweight linear motor having small reduction of motor characteristics to the table feed apparatus.

Among the embodiments described above, a configuration that a nonmagnetic member that becomes a strength member is provided in the space between the yoke fixing members is explained in the modification of the first embodiment (see FIG. 3). Similarly, a configuration that nonmagnetic members arranged at both ends of the field magnet yokes that become strength members are provided at the connecting portions between the yoke fixing members and the field magnet yokes is explained in the modification of the second embodiment (see FIG. 6). Alternatively, it can be arranged such that, in the first embodiment, nonmagnetic members that become strength members are provided at connecting portions between the yoke fixing members and the field magnet yokes, or that, in the second embodiment, a nonmagnetic member that becomes a strength member is provided in the space between the yoke fixing members.

Configurations, operations, and effects as characteristics of an odd-numbered-pole field-magnet linear motor are explained in detail from a viewpoint of field magnets.

In an even-numbered-pole field-magnet linear motor having permanent magnets of a plural number of poles, to increase its thrust, in designing, it is possible to consider that the length of teeth of an armature in a direction orthogonal to an array of magnets is set larger than a slot pitch such that a winding factor is high from a relationship with the armature.

A case of an even-numbered-pole field-magnet linear motor is explained by using odd-numbered-pole field magnets shown in FIG. 7B. The length of teeth 9 corresponds to reference character Ht, and a slot pitch corresponds to reference character Ps. Generally, in the even-numbered-pole field-magnet linear motor, to minimize a copper loss of the armature winding 10, the slot pitch Ps of the armature unit 7 is set large, and a width Bt of the teeth 9 is set small. However, when the width Bt of the teeth 9 is out of a predetermined range and too small, a problem of thrust saturation may occur.

Therefore, it is necessary to achieve a linear motor having a high winding factor by suppressing thrust saturation, in a state where specifications (sizes of the armature and field magnets) of the linear motor that are required by customers are in a steady state. However, as means for increasing a winding factor and suppressing constant thrust saturation of the width Bt of the teeth 9 of the armature unit 7 while keeping the sizes of the armature unit 7 and the field magnet unit 6 as they are, there is a case of employing a linear motor having a reduced number of field magnet poles by changing the number of permanent magnets constituting a field magnet unit 6 side from an even number to an odd number, for example. When a linear motor of even-numbered-pole field magnets is changed to a linear motor of odd-numbered-pole field magnets when the sizes of the armature and the field magnets are not desired to be changed, there is an advantageous effect that the problem of thrust saturation can be suppressed as much as possible by simply changing the number of field magnet poles (the number of permanent magnets) without taking a design method that narrows the width Bt of the teeth 9 in the even-numbered-pole field-magnet linear motor.

A third embodiment is explained next.

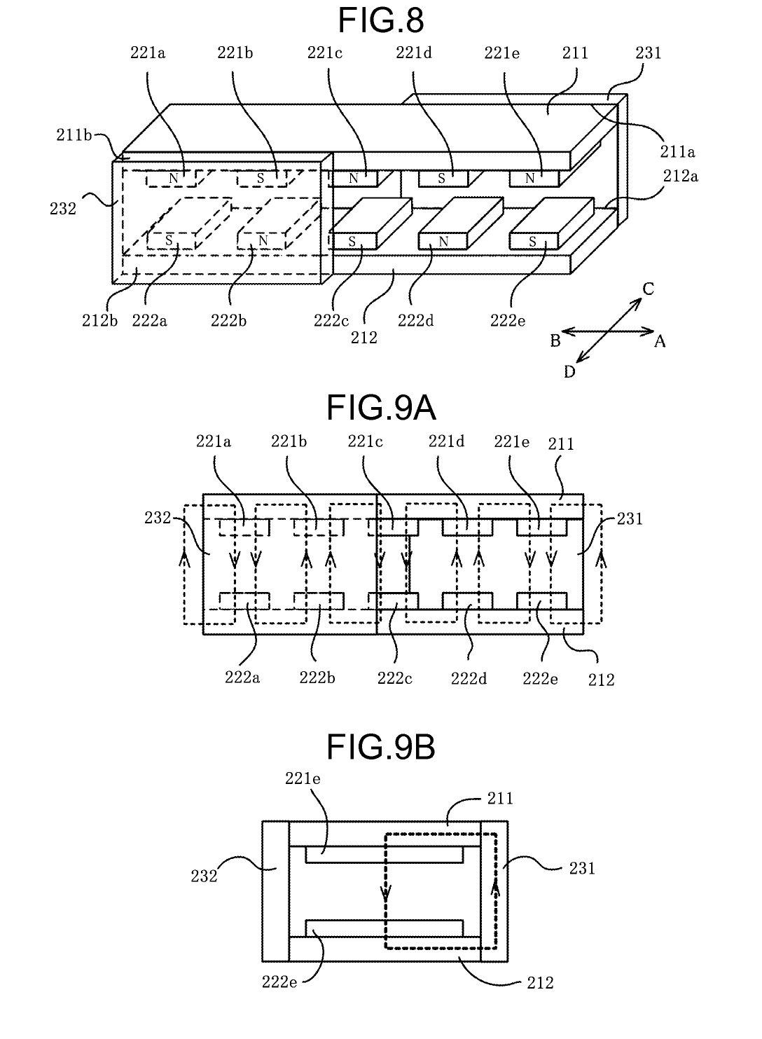

FIG. 8 is a perspective view of a field magnet unit of a linear motor according to the third embodiment. The linear motor according to the third embodiment includes a field magnet unit and an armature unit, one of which is used as a stator and the other is used as a moving element. In FIG. 8, the field magnet unit is used as a moving element as an example. To facilitate the understanding, in FIG. 8, an arrow that represents a moving direction of the field magnet unit and an arrow that represents a direction orthogonal to the moving direction (hereinafter, “orthogonal direction”) are shown, respectively. One side of the moving direction is a side A, and the other side is a side B. One side in the orthogonal direction is a side C, and the other side is a side D. The arrows of the moving direction and the orthogonal direction are also shown in a part of drawings described later.

The field magnet unit according to the third embodiment employs odd-numbered-pole field linear magnets having an odd number of permanent magnets. As shown in FIG. 8, the field magnet unit according to the third embodiment includes a first field magnet yoke 211, a second field magnet yoke 212, first permanent magnets 221a to 221e, second permanent magnets 222a to 222e, a first fixing member 231, and a second fixing member 232.

The first field magnet yoke 211 is configured by a tabular magnetic substance. The second field magnet yoke 212 is configured by a tabular magnetic substance. The first field magnet yoke 211 and the second field magnet yoke 212 form a pair, and are provided such that principal surfaces of the two field magnet yokes face each other via a space.

The total number of the first permanent magnets 221a to 221e is five and is an odd number. The first permanent magnets 221a to 221e are arranged on one principal surface of the first field magnet yoke 211 along a moving direction. The first permanent magnets 221a to 221e are arranged such that their polarities are alternately different. In FIG. 8, as an example, the polarity of the first permanent magnet 221a at a second field magnet yoke 212 side is an N-pole, the polarity of the first permanent magnet 221b at the second field magnet yoke 212 side is an S-pole, and the polarity of the first permanent magnet 221c at the second field magnet yoke 212 side is an N-pole. The polarity of the first permanent magnet 221d at the second field magnet yoke 212 side is an S-pole, and the polarity of the first permanent magnet 221e at the second field magnet yoke 212 side is an N-pole.

The total number of the second permanent magnets 222a to 222e is five and is an odd number. The second permanent magnets 222a to 222e are arranged on one principal surface of the second field magnet yoke 212 along a moving direction. The second permanent magnets 222a to 222e are arranged to face the first permanent magnets 221a to 221e, respectively. Specifically, as shown in FIG. 8, the second permanent magnet 222a faces the first permanent magnet 221a, and the second permanent magnet 222b faces the first permanent magnet 221b. The second permanent magnet 222c faces the first permanent magnet 221c, the second permanent magnet 222d faces the first permanent magnet 221d, and the second permanent magnet 222e faces the first permanent magnet 221e. Polarities of the second permanent magnets 222a to 222e at a first field magnet yoke 211 side are different from the polarities of the first permanent magnets at the second field magnet yoke 212 side that face the second permanent magnets 222a to 222e, respectively. By taking the second permanent magnet 222a as an example, as shown in FIG. 8, because the polarity of the first permanent magnet 221a at the second field magnet yoke 212 side is an N-pole, the polarity of the second permanent magnet 222a at the first field magnet yoke 211 side is an S-pole. Second permanent magnets 222b to 222e are also in a similar relationship.

In the above descriptions, while the total number of each of the first permanent magnets and the second permanent magnets is five, and it suffices that the total number is set to be an odd number. For example, the total number of each of the first permanent magnets and the second permanent magnets can be three or seven.

The first fixing member 231 is configured by a tabular magnetic substance. The first fixing member 231 is fixed to a first side surface portion 211a of the first field magnet yoke 211 and to a first side surface portion 212a of the second field magnet yoke 212, respectively. With this arrangement, the first fixing member 231 fixes the first field magnet yoke 211 and the second field magnet yoke 212 to each other. The first side surface portion 211a of the first field magnet yoke 211 and the first side surface portion 212a of the second field magnet yoke 212 are positioned respectively at one side in the moving direction (the A side in FIG. 8) and also at one side in the orthogonal direction (the C side in FIG. 8).

The second fixing member 232 is configured by a tabular magnetic substance. The second fixing member 232 is fixed to a second side surface portion 211b of the first field magnet yoke 211 and to a second side surface portion 212b of the second field magnet yoke 212, respectively. With this arrangement, the second fixing member 232 fixes the first field magnet yoke 211 and the second field magnet yoke 212 to each other. The second side surface portion 211b of the first field magnet yoke 211 and the second side surface portion 212b of the second field magnet yoke 212 are positioned respectively at the other side in the moving direction (the B side in FIG. 8) and also at the other side in the orthogonal direction (the D side in FIG. 8).

As explained above, the first fixing member 231 and the second fixing member 232 are provided at both ends of the pair of field magnet yokes (211 and 212) in the moving direction. The first fixing member 231 and the second fixing member 232 are provided at symmetrical positions relative to a center on one principal surface of the first field magnet yoke 211 (or the second field magnet yoke 212). The first fixing member 231 and the second fixing member 232 have symmetrical shapes relative to a center on one principal surface of the first field magnet yoke 211 (or the second field magnet yoke 212).

An armature unit has an armature winding, and is provided between the first permanent magnets 221a to 221e and the second permanent magnets 222a to 222e, (not shown) in FIG. 8. A magnetic space is formed between the armature unit and the first permanent magnets 221a to 221e and between the armature unit and the second permanent magnets 222a to 222e, respectively.

FIGS. 9A and 9B are schematic diagrams for explaining a magnetic flux distribution in the field magnet unit according to the third embodiment. FIG. 9A is a front view of the field magnet unit from a viewpoint of the D side in FIG. 8, and FIG. 9B is a side view of the field magnet unit from a viewpoint of the A side in FIG. 8. Dashed-line arrows in FIGS. 9A and 9B represent a flow of a magnetic flux.

As shown in FIG. 8, in the field magnet unit according to the third embodiment, both ends of the pair of field magnet yokes (211 and 212) are fixed to each other by the first fixing member 231 and the second fixing member 232 that are configured by a magnetic substance. Therefore, in addition to a magnetic circuit shown in FIG. 9A, a magnetic circuit shown in FIG. 9B is also additionally formed. As shown in FIG. 9B, in this additional magnetic circuit, a magnetic flux passes from the first permanent magnets 221c to 221e to the first field magnet yoke 211, the first fixing member 231, the second field magnet yoke 212, and the second permanent magnets 222c to 222e, and then returns to the first permanent magnets 221c to 221e again. In this additional magnetic circuit, although not shown in FIG. 9B, there is also formed a route through which a magnetic flux passes from the first permanent magnets 221a to 221c to the first field magnet yoke 211, the second fixing member 232, the second field magnet yoke 212, and the second permanent magnets 222a to 222c, and then returns to the first permanent magnets 221a to 221c again. Therefore, leakage magnetic fluxes at both ends of the field magnet unit in the moving direction are reduced. The field magnet unit from a viewpoint of an armature unit (not shown) has relatively cyclical boundaries at both ends of the field magnet unit, and has field magnets that are equivalent to those having an even number of poles. That is, the amount of biases generated in a magnetic flux density in the magnetic space between the armature unit and the field magnet unit can be reduced.

As explained above, according to the third embodiment, by providing the first fixing member 231 and the second fixing member 232, the amount of biases generated in a magnetic flux density in the magnetic space between the armature unit and the field magnet unit can be reduced even when the field magnet unit has odd-numbered-pole field magnets. As a result, even when the field magnet unit has odd-numbered-pole field magnets, sufficient motor characteristics can be obtained. The pair of field magnet yokes (211 and 212) can be fixed to each other by nonmagnetic members that become strength members, in addition to the first fixing member 231 and the second fixing member 232.

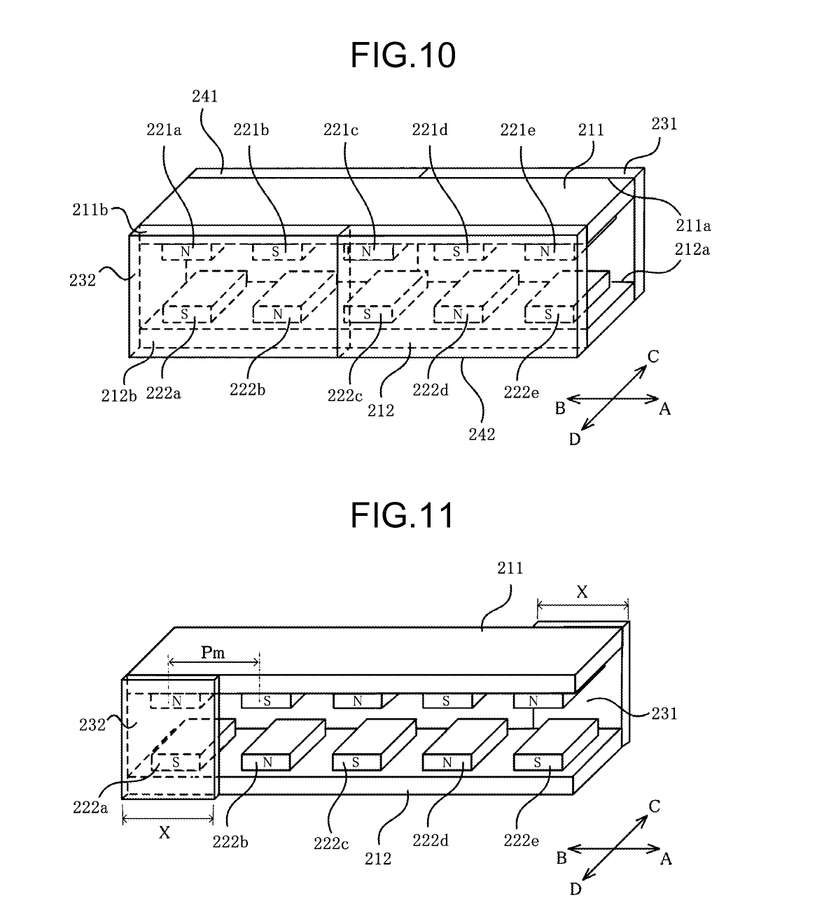

FIG. 10 is a perspective view of a field magnet unit of a linear motor according to a modification of the third embodiment. As shown in FIG. 10, the field magnet unit additionally includes a first nonmagnetic member 241 and a second nonmagnetic member 242. The first nonmagnetic member 241 is fixed to a side surface portion other than the first side surface portion 211a of the first field magnet yoke 211 positioned at one side in the orthogonal direction (the C side in FIG. 10), and to a side surface portion other than the first side surface portion 212a of the second field magnet yoke 212 positioned at the one side in the orthogonal direction (the C side in FIG. 10). With this arrangement, the first nonmagnetic member 241 fixes the first field magnet yoke 211 and the second field magnet yoke 212 to each other. The second nonmagnetic member 242 is fixed to a side surface portion other than the second side surface portion 211b of the first field magnet yoke 211 positioned at the other side in the orthogonal direction (the D side in FIG. 10), and to a side surface portion other than the second side surface portion 212b of the second field magnet yoke 212 positioned at the other side in the orthogonal direction (the D side in FIG. 10). With this arrangement, the second nonmagnetic member 242 fixes the first field magnet yoke 211 and the second field magnet yoke 212 to each other.

By providing a configuration as shown in FIG. 10, the strength of the field magnet unit can be maintained or improved while improving manufacturability and achieving compactness and lightweight. Alternatively, only one of the first nonmagnetic member 241 and the second nonmagnetic member 242 can be provided. In this case, the strength of the field magnet unit can be also maintained or improved while improving manufacturability and achieving compactness and lightweight, as compared with a case where none of the first nonmagnetic member 241 and the second nonmagnetic member 242 is provided.

A fourth embodiment is explained next.

FIG. 11 is a perspective view of a field magnet unit of a linear motor according to the fourth embodiment. In FIG. 11, the fourth embodiment is different from the third embodiment in that a width X of each of the first fixing member 231 and the second fixing member 232 is set equal to or larger than the length of the magnetic pole pitch Pm of the first permanent magnets 221a to 221e. This different point is mainly explained below.

As described above, the width X of each of the first fixing member 231 and the second fixing member 232 is set equal to or larger than the length of the magnetic pole pitch Pm of the first permanent magnets 221a to 221e. The length of the magnetic pole pitch Pm of the first permanent magnets 221a to 221e is also the length of a magnetic pole pitch of the second permanent magnets 222a to 222e. The width X of each of the first and second fixing members 231 and 232 is preferably equal to or smaller than a width in a moving direction of the first field magnet yoke 211 and the second field magnet yoke 212.

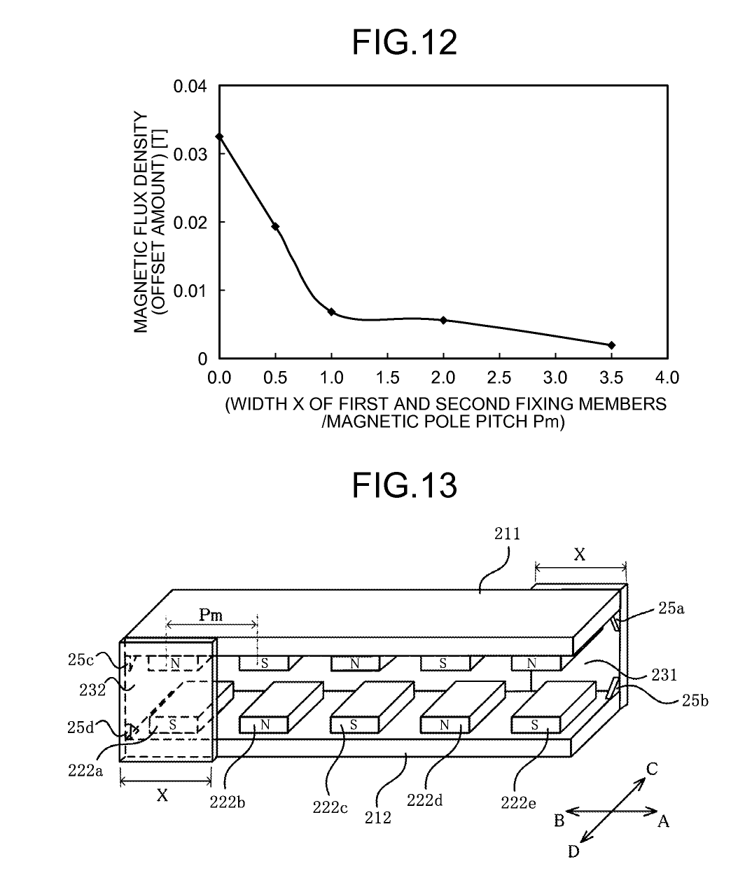

FIG. 12 is a graph of a change of a magnetic flux density relative to a width of first and second fixing members according to the fourth embodiment. In the graph of FIG. 12, the lateral axis represents the ratio of the width X to the magnetic pole pitch Pm, and the vertical axis represents a numerical value of the magnetic flux density (T) at a center portion of the first permanent magnet 221a in a thickness direction. FIG. 12 depicts a relationship between this ratio and the magnetic flux density. It is clear from FIG. 12 that an offset amount of the magnetic flux of the first permanent magnet 221a becomes equal to or smaller than 0.005 and becomes stable when X/Pm is equal to or higher than 1.0. Therefore, leakage magnetic fluxes at both ends of the field magnet unit can be optimally reduced by setting the width X of the first and second fixing members 231 and 232 at equal to or larger than the magnetic pole pitch Pm.

Because the field magnet unit of the linear motor according to the fourth embodiment is configured as described above, leakage magnetic fluxes at both ends can be further reduced than those in the third embodiment. As a result, the amount of biases generated in a magnetic flux density in the magnetic space between the armature unit and the field magnet unit can be further reduced, and sufficient motor characteristics can be obtained.

Contact members 25a to 25d configured by a nonmagnetic substance that become strength members can be further provided in the field magnet unit according to the fourth embodiment.

FIG. 13 is a perspective view of a field magnet unit of a linear motor according to a modification of the fourth embodiment. In FIG. 13, the contact members 25a to 25d are in a triangular pole shape, and are configured by a nonmagnetic substance. The contact member 25a is provided in contact with both the first field magnet yoke 211 and the first fixing member 231 to cover a right-angle connecting portion of the first field magnet yoke 211 and the first fixing member 231 from the other side in the orthogonal direction (the D side in FIG. 13). The contact member 25b is provided in contact with both the second field magnet yoke 212 and the first fixing member 231 to cover a right-angle connecting portion of the second field magnet yoke 212 and the first fixing member 231 from the other side in the orthogonal direction (the D side in FIG. 13). The contact member 25c is provided in contact with both the first field magnet yoke 211 and the second fixing member 232 to cover a right-angle connecting portion of the first field magnet yoke 211 and the second fixing member 232 from one side in the orthogonal direction (the C side in FIG. 13). The contact member 25d is provided in contact with both the second field magnet yoke 212 and the second fixing member 232 to cover a right-angle connecting portion of the second field magnet yoke 212 and the second fixing member 232 from the one side in the orthogonal direction (the C side in FIG. 13).

By providing a configuration as shown in FIG. 13, the strength of the field magnet unit can be maintained or improved while improving manufacturability and achieving compactness and lightweight. Alternatively, only one of the contact members 25a to 25d can be provided. In this case, the strength of the field magnet unit can be also maintained or improved while improving manufacturability and achieving compactness and lightweight, as compared with a case where none of the contact members 25a to 25d is provided.

The modification of the fourth embodiment shown in FIG. 13 can be applied to the third embodiment. Conversely, the modification of the third embodiment shown in FIG. 10 can be applied to the fourth embodiment.

The linear motor according to the third and fourth embodiments can be used for a table feed apparatus of a factory automation machine such as a machine tool and a semiconductor manufacturing apparatus.

An example in which the linear motor according to the third and fourth embodiments is applied to a table feed apparatus of a machine tool is explained next.

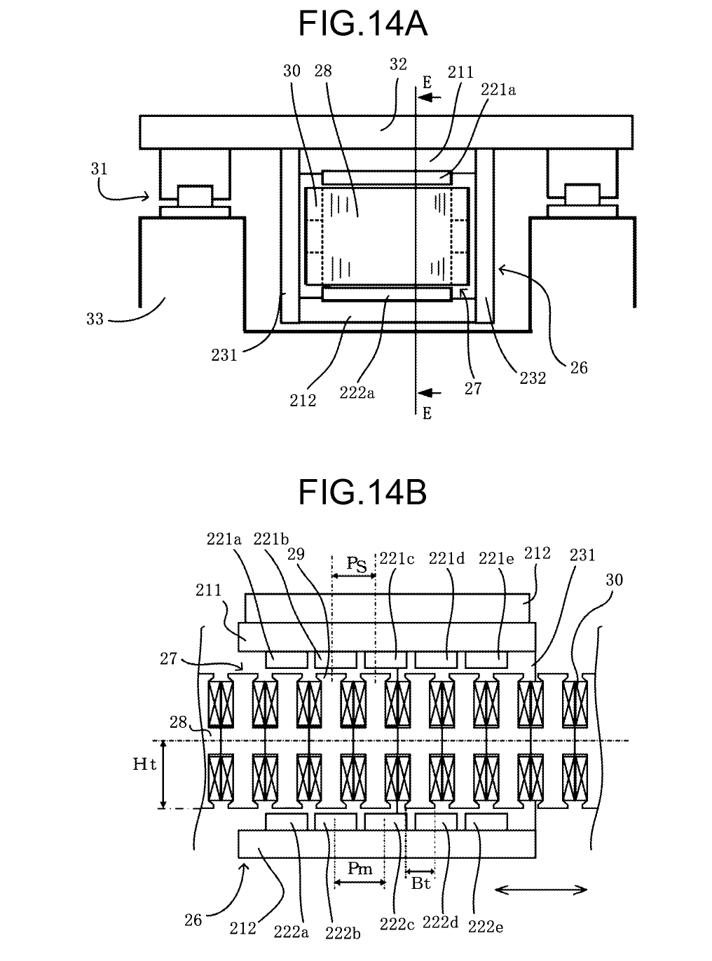

FIGS. 14A and 14B are an example in which the linear motor according to the third and fourth embodiments is applied to a table feed apparatus of a machine tool. FIG. 14A is a side cross-sectional view of the table feed apparatus, and FIG. 14B is a plan view of the table feed apparatus. FIG. 14B is a cross-sectional view along a line E-E in FIG. 14A. In the example shown in FIGS. 14A and 14B, the linear motor according to the third embodiment is used.

In FIGS. 14A and 14B, the linear motor includes a field magnet unit 26 and an armature unit 27. In an example shown in FIGS. 14A and 14B, the field magnet unit 26 is a moving element, and the armature unit 27 is a stator. An arrow in FIG. 14B represents a moving direction of the field magnet unit 26. The field magnet unit 26 has a configuration shown in FIG. 8, and thus detailed explanations thereof will be omitted. The armature unit 27 includes an armature core 28 and an armature winding 30. The armature winding 30 is mounted on teeth 29 of the armature core 28. The armature unit 27 passes through the inside of the field magnet unit 26 (between the first permanent magnets 221a to 221e and the second permanent magnets 222a to 222e) as shown in FIGS. 14A and 14B. The armature unit 27 is provided to face the first permanent magnets 221a to 221e and the second permanent magnets 222a to 222e, respectively via a magnetic space. A table 32 is provided on an upper surface (the other principal surface of the first field magnet yoke 211) of the field magnet unit 26. The table 32 is slidably supported by a linear guide 31 that is provided on a fixing table 33. When a linear motor that can obtain sufficient motor characteristics is used in the table feed apparatus as explained above, high-precision positioning feed can be achieved.

In an even-numbered-pole field-magnet linear motor having an even number of permanent magnets, in order to increase its thrust, in designing, it is possible to consider that the length of teeth of an armature unit in a direction orthogonal to an array of magnets is set larger than a slot pitch such that a winding factor is high from a relationship with the armature unit. On the other hand, the width of the teeth in a direction parallel with the array of magnets needs to be small to minimize a copper loss of the armature winding. This arrangement is explained with reference to FIG. 14B. In FIG. 14B, the length of teeth corresponds to reference character Ht, and a slot pitch corresponds to reference character Ps. To minimize a copper loss of the armature winding 30, the slot pitch Ps of the armature unit 27 is set large, and the width Bt of the teeth is set small. However, when the width Bt of the teeth is out of a predetermined range and too small, a problem of thrust saturation may occur.

Therefore, it is necessary to achieve a linear motor having a high winding factor by suppressing thrust saturation, in a state where specifications (sizes of the armature unit and the field magnet unit) of the linear motor that are required by customers are in a steady state. However, as means for increasing a winding factor and suppressing constant thrust saturation of the width Bt of the teeth of the armature unit 27 while keeping the sizes of the armature unit 27 and the field magnet unit 26 as they are, there is a case of employing a linear motor having a reduced number of field magnet poles by changing the number of permanent magnets constituting a field magnet unit 26 side from an even number to an odd number, for example. When an even-numbered-pole field-magnet linear motor is changed to an odd-numbered-pole field-magnet linear motor when the sizes of the armature unit and the field magnet unit are not desired to be changed, there is an advantageous effect that the problem of thrust saturation can be suppressed as much as possible by simply changing the number of field magnet poles (the number of permanent magnets) without taking a design method that narrows the width Bt of the teeth in the even-numbered-pole field-magnet linear motor.

A fifth embodiment is explained next.

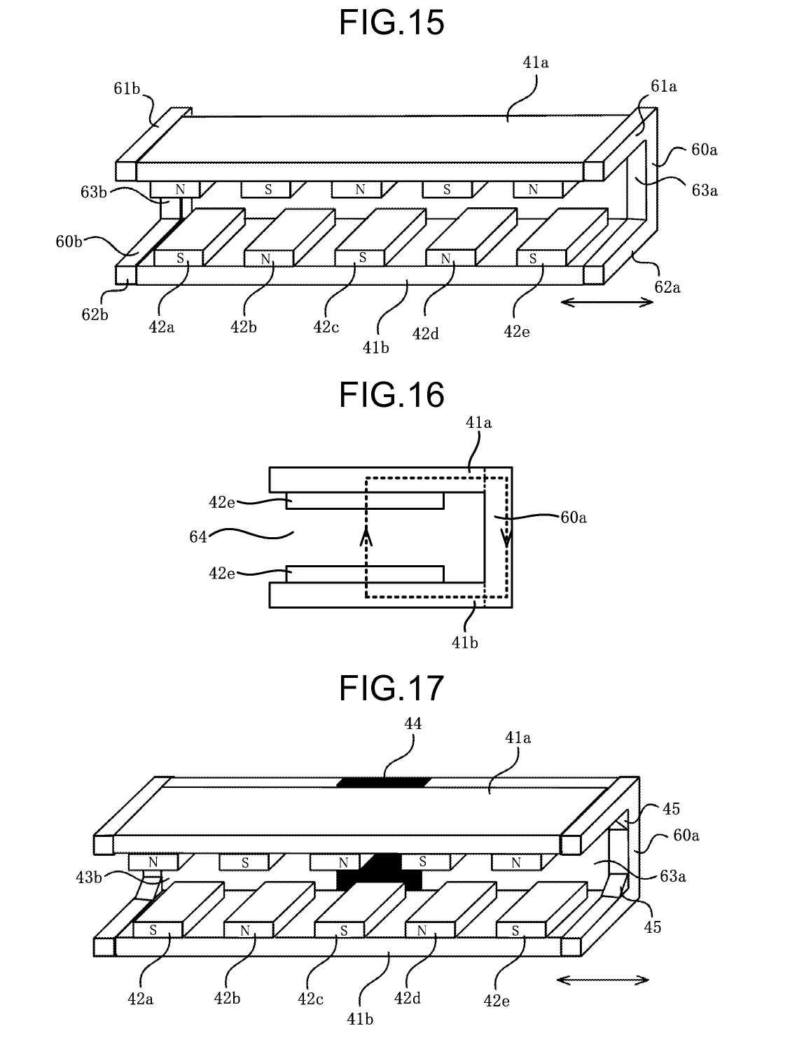

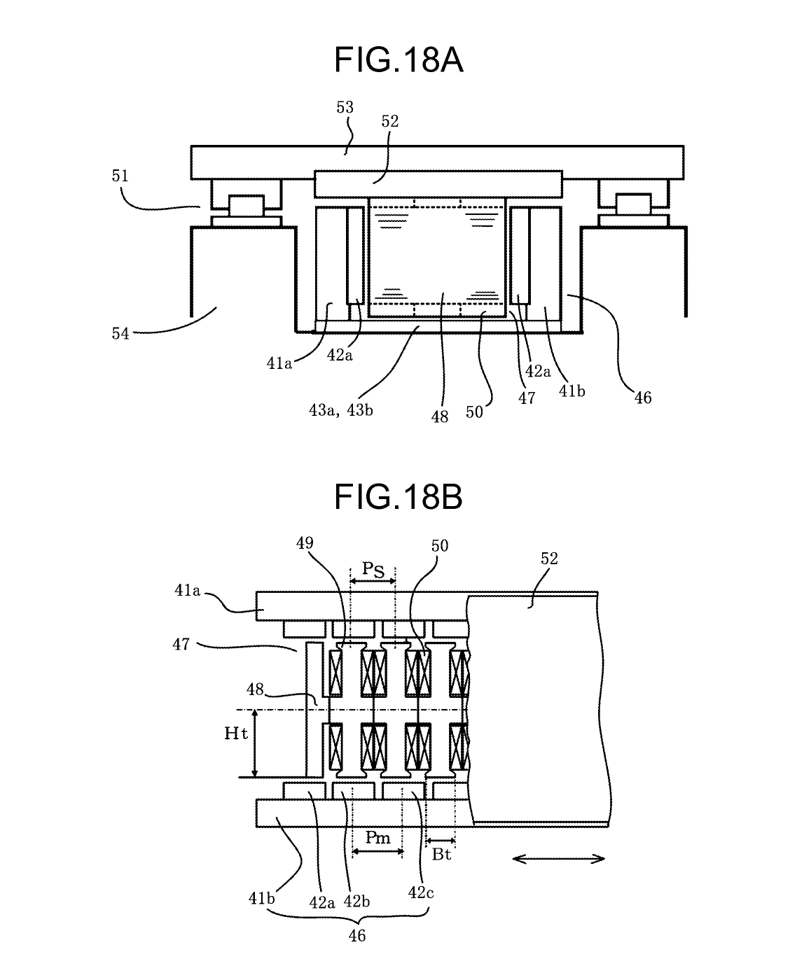

FIG. 15 is a perspective view of a field magnet unit of a linear motor according to the fifth embodiment. The linear motor according to the fifth embodiment includes a field magnet unit 46 (see FIGS. 18A and 18B) as a field magnet unit, and an armature unit 47 (see FIGS. 18A and 18B) as an armature unit. The field magnet unit 46 includes a rectangular and tabular first magnetic member 41a and a rectangular and tabular second magnetic member 41b. The first magnetic member 41a and the second magnetic member 41b as a pair of tabular field magnet yokes are arranged substantially in parallel with each other. A longitudinal direction of the first magnetic member 41a and the second magnetic member 41b is the same as a moving direction (an arrow direction in FIG. 15) in which the armature unit 47 moves relatively to the field magnet unit 46.

In the first magnetic member 41a, an odd number (five in the fifth embodiment) of permanent magnets 42a to 42e of which magnetization directions are different are alternately arranged along a moving direction. Similarly, in the second magnetic member 41b, an odd number (five in the fifth embodiment) of permanent magnets 42a to 42e of which magnetization directions are different are alternately arranged along a moving direction.

The armature unit 47 is wound with an armature winding 50 (see FIGS. 18A and 18B). The armature unit 47 is arranged between the first magnetic member 41a and the second magnetic member 41b.

The first magnetic member 41a and the second magnetic member 41b are arranged such that their respective permanent magnets 42a to 42e face each other and that polarities of opposite permanent magnets are different from each other. Both side surfaces of the first magnetic member 41a and the second magnetic member 41b in a longitudinal direction are coupled to each other by coupling members 60a and 60b of a magnetic substance.

The linear motor according to the fifth embodiment is configured such that the armature unit 47 moves relatively to the field magnet unit 46 by conducting a current to the armature winding 50. Each of the coupling members 60a and 60b has a substantial U-shape having an opening 64 (see FIG. 16). The opening 64 functions as an interference avoiding unit that avoids interference with the armature unit 47 that moves in a moving direction.

Shapes of the coupling members 60a and 60b are explained in detail below. The coupling members 60a and 60b include first coupling units 61a and 61b of a rectangular-cylindrical and magnetic substance provided along a short direction of the first magnetic member 41a, and second coupling units 62a and 62b of a rectangular-cylindrical and magnetic substance provided along a short direction of the second magnetic member 41b. The coupling members 60a and 60b include third coupling units 63a and 63b of a rectangular-cylindrical and magnetic substance that couple ends in a same direction of the first coupling units 61a and 61b and the second coupling units 62a and 62b in a longitudinal direction.

A magnetic flux distribution of the linear motor according to the fifth embodiment is explained next.

FIG. 16 is a schematic diagram for explaining the magnetic flux distribution of the field magnet unit according to the fifth embodiment. A dashed-line arrow in FIG. 16 represents a flow of a magnetic flux. As shown in FIG. 16, because the linear motor according to the embodiment includes the coupling members 60a and 60b of a magnetic substance that partially couple the magnetic members 41a and 42b, a magnetic circuit is formed, which passes through the permanent magnets 42a to 42e, the magnetic members 41a and 41b, and the coupling members 60a and 60b via a magnetic gap. Therefore, leakage magnetic fluxes at both ends of the field magnet unit 46 as a field magnet unit in a moving direction are reduced. The field magnet unit 46 from a viewpoint of the armature unit 47 (not shown in FIG. 16) becomes in a state identical to that the field magnet unit 46 has relatively cyclical boundaries at both ends of the field magnet unit 46. Therefore, magnetic flux distributions that interlink with the armature unit 47 by the permanent magnets 42a and 42e at both ends of the magnetic members 41a and 41b become equivalent to magnetic flux distributions that interlink with the armature unit 47 by the permanent magnets 42b, 42c, and 42d at a center portion. Consequently, the amount of biases generated in a magnetic flux density in the magnetic space between the armature unit 47 as an armature unit and the field magnet unit 46 as a field magnet unit can be reduced.

As described above, according to the fifth embodiment, in a linear motor of odd-numbered-pole field magnets constituting the field magnet unit 46 having an odd number of the permanent magnets 42a to 42e, the two coupling members 60a and 60b are provided to couple the magnetic members 41a and 41b such that both ends of the magnetic members 41a and 41b in the longitudinal direction are closed. With this arrangement, magnetic fluxes at both ends can return to a center side in the moving direction through the two coupling members 60a and 60b. Consequently, from the viewpoint of the armature unit 47, the field magnet unit 46 has relatively cyclical boundaries at both ends of the field magnet unit 46. Accordingly, field magnets can be obtained in which magnetic flux distributions of magnets at both ends of the magnetic members 41a and 41b become equivalent to magnetic flux distributions of magnets at a center portion.

That is, according to the fifth embodiment, by providing the two coupling members 60a and 60b, the amount of biases generated in the magnetic flux density in the magnetic space between the armature unit and the field magnet unit can be reduced even when the field magnet unit has odd-numbered-pole field magnets (an odd number of permanent magnets). As a result, sufficient motor characteristics can be also obtained when the field magnet unit has odd-numbered-pole field magnets. Consequently, a high-performance linear motor can be provided.

A sixth embodiment is explained next.

FIG. 17 is a perspective view of a field magnet unit of a linear motor according to the sixth embodiment. In FIG. 17, the field magnet unit according to the sixth embodiment is provided by adding at least one of members described later to the field magnet unit according to the fifth embodiment.

In the linear motor according to the sixth embodiment, the coupling members 60a and 60b include reinforcing members 45 of a magnetic substance or a nonmagnetic substance that reinforce the coupling members 60a and 60b. As an example of the reinforcing members 45, ribs in a triangular pole shape or the like can be mentioned. However, reinforcing members are not limited thereto and reinforcing members that can reinforce the coupling members 60a and 60b are sufficient.

The linear motor according to the sixth embodiment is provided to have a clearance on a side surface in the short direction and on both sides in the longitudinal direction (moving direction) of the first magnetic member 41a and the second magnetic member 41b, respectively. The linear motor according to the sixth embodiment includes a second coupling member 43a of a magnetic substance and a third coupling member 43b of a magnetic substance that couple the first magnetic member 41a and the second magnetic member 41b. The second coupling member 43a and the third coupling member 43b also function as yoke fixing members that fix yokes.

The second coupling member 43a and the third coupling member 43b are mutually in a symmetrical shape, and are provided at mutually symmetrical positions by using as a line-symmetric axis a center line in the longitudinal direction of the magnetic members 41a and 41b (moving direction of the linear motor). A strength balance and a magnetic balance of the linear motor can be secured based on this symmetry.

Further, the linear motor according to the sixth embodiment also includes a fourth coupling member 44 of a nonmagnetic substance that is provided between the second coupling member 43a and the third coupling member 43b and couples the first magnetic member 41a and the second magnetic member 41b. When the fourth coupling member 44 is formed with a material of a nonmagnetic substance having lightweight and high rigidity such as reinforced plastic, both high rigidity and lightweight of the linear motor can be achieved.

It is not always necessarily that all of the reinforcing members 45, the second coupling member 43a, the third coupling member 43b, and the fourth coupling member 44 are included in the linear motor, and it suffices that any one of or an arbitrary combination of these members is included. In addition, the second coupling member 43a, the third coupling member 43b, and the fourth coupling member 44 can be configured by a material of any one of a magnetic substance and a nonmagnetic substance. Accordingly, in addition to effects identical to those of the first embodiment, it is possible to obtain a significant effect that the rigidity of the linear motor is improved.

It is also possible that only the second coupling member 43a of a nonmagnetic substance is provided, for example. In this case, the second coupling member 43a can be provided at any position in the longitudinal direction of the magnetic members 41a and 41b. It is desirable to provide the second coupling member 43a near a center portion in the longitudinal direction of the magnetic members 41a and 41b, because a strength balance of the linear motor can be secured.

Further, it is also possible that only the second coupling member 43a of a magnetic substance is provided, for example. In this case, the size of the second coupling member 43a in the longitudinal direction is set substantially the same as the size of the magnetic members 41a and 41b in the longitudinal direction. Alternatively, the second coupling member 43a of which the size in the longitudinal direction is shorter than that of the magnetic members 41a and 41b in the longitudinal direction is positioned near a center portion in the longitudinal direction of the magnetic members 41a and 41b. In this case, the second coupling member 43a of a magnetic substance is provided in symmetry by using a center line in the longitudinal direction of the magnetic members 41a and 41b (moving direction of the linear motor) as a line-symmetric axis. Based on this symmetry, a strength balance and a magnetic balance can be secured. An opening in a symmetrical shape such as a through-hole can be also provided near a center portion of the second coupling member 43a in the longitudinal direction. With this arrangement, an effect such as a lightweight and radiation performance of the linear motor can be obtained while improving the rigidity of the linear motor and securing the strength and magnetic balances.

An example in which the linear motor according to the fifth and sixth embodiments is applied to a table feed apparatus of a machine tool is explained next.

FIGS. 18A and 18B are an example in which the linear motor according to the fifth and sixth embodiments is applied to a table feed apparatus of a machine tool. FIG. 18A is a side cross-sectional view of the table feed apparatus, and FIG. 18B is a plan view of the table feed apparatus. Specifically, FIG. 18B depicts a state where a table shown in FIG. 18A is removed, and is a diagram viewed from above along an advancing direction. It is clear from FIG. 18B that the armature winding 50 is wound around teeth 49 provided in an armature core 48. The teeth 49 have the teeth width Bt and a teeth length Ht, and are provided in a slot pitch Ps. Meanwhile, the permanent magnets 42a to 42e are provided in the magnetic pole pitch Pm.

The table feed apparatus shown in FIGS. 18A and 18B includes a base member 54 that has a concave portion and a substantially U-shape cross section and linear guides 51 that are provided at both sides of the base member 54 that has the substantially U-shape cross section. The table feed apparatus also includes a table 53 that is coupled to the linear guides 51 and is guided to a moving direction (longitudinal direction of the magnetic members 41a and 41b) by the linear guides 51. Configurations of the field magnet unit 46 and the armature unit 47 are substantially identical to those of the linear motor explained above. The arrow direction in FIG. 18B represents a moving direction of the table 53.

In the table feed apparatus shown in FIGS. 18A and 18B, the field magnet unit 46 is coupled to the concave portion of the base member 54, and the armature unit 47 is coupled to the table 53 via a fitting member 52. Therefore, in this table feed apparatus, the table 53 is fed to the moving direction (longitudinal direction of the magnetic members 41a and 41b) by conducting a current to the armature winding 50.

The field magnet unit 46 can be coupled to the table 53, and also the armature unit 47 can be coupled to the concave portion of the base part 54 via the fitting member 52.

In this manner, by applying a high-performance linear motor to the table feed apparatus, a high-performance table feed apparatus can be provided and a high-performance positioning feed can be achieved.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A linear motor comprising:
a field magnet unit that includes a first field magnet yoke and a second field magnet yoke each of which has an odd number of permanent magnets arranged thereon in a longitudinal direction such that polarities of the permanent magnets are alternately different, the first field magnet yoke and the second field magnet yoke being arranged such that respective permanent magnets face each other and that polarities of the facing permanent magnets are different from each other;
an armature unit that is wound with a winding and is arranged between the first field magnet yoke and the second field magnet yoke; and
a connecting unit that is configured by a magnetic substance and connects the first field magnet yoke and the second field magnet yoke, wherein
one of the field magnet unit and the armature unit moves relatively to the other by conducting a current to the armature winding.

2. The linear motor according to claim 1, wherein the connecting unit includes fixing members that partially connect one end of the first field magnet yoke and one end of the second field magnet yoke in a direction orthogonal to a longitudinal direction.

3. The linear motor according to claim 2, wherein the fixing members connect ends at symmetrical positions of both ends of the first field magnet yoke and the second field magnet yoke in a longitudinal direction, respectively.

4. The linear motor according to claim 2, wherein a width of the fixing members in a longitudinal direction of the first field magnet yoke and the second field magnet yoke is equal to or larger than a pole pitch of the permanent magnets.

5. The linear motor according to claim 2, further comprising nonmagnetic members that are provided as strength members at connecting portions where the fixing members and the first field magnet yoke are orthogonal to each other and at connecting portions where the fixing members and the second field magnet yoke are orthogonal to each other.

6. The linear motor according to claim 3, further comprising a nonmagnetic member that is provided as a strength member in a space between the fixing members that are provided at both ends of the first field magnet yoke and the second field magnet yoke.

7. The linear motor according to claim 1, wherein
the connecting unit includes
a first fixing member that fixes the first field magnet yoke and the second field magnet yoke to each other by connecting first side surface portions of the first field magnet yoke and the second field magnet yoke that are positioned at one side in the longitudinal direction and also at one side in a direction orthogonal to the longitudinal direction, and
a second fixing member that fixes the first field magnet yoke and the second field magnet yoke to each other by connecting second side surface portions of the first field magnet yoke and the second field magnet yoke that are positioned at the other side in a longitudinal direction and also at the other side in a direction orthogonal to the longitudinal direction.

8. The linear motor according to claim 7, wherein
the first field magnet yoke and the second field magnet yoke are arranged such that one principal surface of the first field magnet yoke on which permanent magnets are arranged and one principal surface of the second field magnet yoke on which permanent magnets are arranged face each other,
the first fixing member and the second fixing member are provided at positions that are symmetrical with a center on one principal surface of the first field magnet yoke, and
shapes of the first fixing member and the second fixing member are symmetrical with the center on the one principal surface of the first field magnet yoke.

9. The linear motor according to claim 7, wherein a width of each of the first fixing member and the second fixing member in a longitudinal direction of the first field magnet yoke and the second field magnet yoke is equal to or larger than a pole pitch of permanent magnets.

10. The linear motor according to claim 7, wherein the field magnet unit further includes a first nonmagnetic member that connects side surface portions other than the first side surface portions of the first field magnet yoke and the second field magnet yoke that are positioned at one side in a direction orthogonal to a longitudinal direction of the first field magnet yoke and the second field magnet yoke.

11. The linear motor according to claim 10, wherein the field magnet unit further includes a second nonmagnetic member that connects side surface portions other than the second side surface portions of the first field magnet yoke and the second field magnet yoke that are positioned at the other side in a direction orthogonal to a longitudinal direction of the first field magnet yoke and the second field magnet yoke.

12. The linear motor according to claim 7, wherein the field magnet unit further includes a nonmagnetic member that connects side surface portions other than the second side surface portions of the first field magnet yoke and the second field magnet yoke that are positioned at the other side in a direction orthogonal to a longitudinal direction of the first field magnet yoke and the second field magnet yoke.

13. The linear motor according to claim 7, wherein
the field magnet unit further includes
a first contact member that is configured by a nonmagnetic substance and is provided in contact with both the first field magnet yoke and the first fixing member such that the first contact member covers a connecting portion of the first field magnet yoke and the first fixing member from the other side in a direction orthogonal to a longitudinal direction of the first field magnet yoke and the second field magnet yoke, and
a second contact member that is configured by a nonmagnetic substance and is provided in contact with both the second field magnet yoke and the first fixing member such that the second contact member covers a connecting portion of the second field magnet yoke and the first fixing member from the other side in a direction orthogonal to a longitudinal direction of the first field magnet yoke and the second field magnet yoke.

14. The linear motor according to claim 13, wherein
the field magnet unit further includes
a third contact member that is configured by a nonmagnetic substance and is provided in contact with both the first field magnet yoke and the second fixing member such that the third contact member covers a connecting portion of the first field magnet yoke and the second fixing member from one side in a direction orthogonal to a longitudinal direction of the first field magnet yoke and the second field magnet yoke, and
a fourth contact member that is configured by a nonmagnetic substance and is provided in contact with both the second field magnet yoke and the second fixing member such that the fourth contact member covers a connecting portion of the second field magnet yoke and the second fixing member from one side in a direction orthogonal to a longitudinal direction of the first field magnet yoke and the second field magnet yoke.

15. The linear motor according to claim 7, wherein
the field magnet unit further includes
a first contact member that is configured by a nonmagnetic substance and is provided in contact with both the first field magnet yoke and the second fixing member such that the first contact member covers a connecting portion of the first field magnet yoke and the second fixing member from one side in a direction orthogonal to a moving direction, and
a second contact member that is configured by a nonmagnetic substance and is provided in contact with both the second field magnet yoke and the second fixing member such that the second contact member covers a connecting portion of the second field magnet yoke and the second fixing member from one side in a direction orthogonal to the moving direction.

16. The linear motor according to claim 1, wherein the connecting unit includes a coupling member that couples both side surfaces of the first field magnet yoke and the second field magnet yoke in a longitudinal direction.

17. The linear motor according to claim 16, wherein the coupling member has an opening.

18. The linear motor according to claim 16, wherein the coupling member has a substantial U-shape.

19. The linear motor according to claim 16, wherein the coupling member includes a reinforcing unit that reinforces the coupling member.

20. The linear motor according to claim 16, wherein
the coupling member includes
first coupling units of a rectangular-cylindrical shape that are provided along a short direction of the first field magnet yoke,
second coupling units of a rectangular-cylindrical shape that are provided along a short direction of the second field magnet yoke, and
third coupling units of a rectangular-cylindrical shape that couple ends in a same direction of the first coupling units and the second coupling unit in a longitudinal direction.

21. The linear motor according to claim 16, further comprising second coupling members and third coupling members that are provided on side surfaces in a short direction of the first field magnet yoke and the second field magnet yoke and at both sides in a longitudinal direction of the first field magnet yoke and the second field magnet yoke and that couple the first field magnet yoke and the second field magnet yoke.

22. The linear motor according to claim 16, further comprising:
second coupling members and third coupling members that are provided on side surfaces in a short direction of the first field magnet yoke and the second field magnet yoke and at both sides in a longitudinal direction of the first field magnet yoke and the second field magnet yoke and that couple the first field magnet yoke and the second field magnet yoke; and
fourth coupling members that are provided between the second coupling members and the third coupling members and that couple the first field magnet yoke and the second field magnet yoke.

23. The linear motor according to claim 16, further comprising second coupling members of a nonmagnetic substance that is provided on side surfaces in a short direction of the first field magnet yoke and the second field magnet yoke and that couple the first field magnet yoke and the second field magnet yoke.

24. The linear motor according to claim 16, further comprising second coupling members of a nonmagnetic substance that are symmetrically provided by using as a line-symmetric axis a center line in a longitudinal direction of the first field magnet yoke and the second field magnet yoke, on side surfaces in a short direction of the first field magnet yoke and the second field magnet yoke, and that couple the first field magnet yoke and the second field magnet yoke.

25. A linear motor comprising:
a field magnet unit that includes a first field magnet yoke and a second field magnet yoke each of which has an odd number of permanent magnets arranged thereon in a longitudinal direction such that polarities of the permanent magnets are alternately different, the first field magnet yoke and the second field magnet yoke being arranged such that respective permanent magnets face each other and that polarities of the facing permanent magnets are different from each other;
an armature unit that is wound with a winding and is arranged between the first field magnet yoke and the second field magnet yoke; and
a means for forming a magnetic circuit that passes through permanent magnets of the first field magnet yoke and permanent magnets of the second field magnet yoke via a magnetic space between the first field magnet yoke and the second field magnet yoke, wherein
one of the field magnet unit and the armature unit moves relatively to the other by conducting a current to the armature winding.

26. A table feed apparatus comprising:
a linear motor including
a field magnet unit that includes a first field magnet yoke and a second field magnet yoke each of which has an odd number of permanent magnets arranged thereon in a longitudinal direction such that polarities of the permanent magnets are alternately different, the first field magnet yoke and the second field magnet yoke being arranged such that respective permanent magnets face each other and that polarities of the facing permanent magnets are different from each other,
an armature unit that is wound with a winding and is arranged between the first field magnet yoke and the second field magnet yoke, and
a connecting unit that is configured by a magnetic substance and connects the first field magnet yoke and the second field magnet yoke;
a table that is provided on one of the field magnet unit and the armature unit; and
a linear guide that movably supports the table in a longitudinal direction of the first field magnet yoke and the second field magnet yoke, wherein
in the linear motor, one of the field magnet unit and the armature unit moves relatively to the other by conducting a current to the armature winding.
